(19) United States
(12) Patent Application Publication
(10) Pub. No.: US 2020/0233397 A1
(43) Pub. Date: Jul. 23, 2020

(54) SYSTEM, METHOD AND COMPUTER-ACCESSIBLE MEDIUM FOR MACHINE CONDITION MONITORING

(71) Applicant: NEW YORK UNIVERSITY, New York, NY (US)

(72) Inventors: Juan Pablo Bello, New York, NY (US); Charlie Mydlarz, Brooklyn, NY (US); Justin Salamon, San Francisco, CA (US)

(21) Appl. No.: 16/750,378

(22) Filed: Jan. 23, 2020

Related U.S. Application Data
(60) Provisional application No. 62/795,811, filed on Jan. 23, 2019.

(51) Int. Cl. G05B 19/4065; G05B 19/408; G06N 20/20; G06K 9/62

(52) U.S. Cl. CPC G05B 19/4065; G05B 19/408; G05B 2219/37433; G06K 9/6256; G05B 2219/37269; G06N 20/20

(57) ABSTRACT

A system for monitoring a condition of a machine includes an acoustic detector configured to capture an audio signal of the machine. A controller is communicatively coupled to the audio detector and configured to transmit the audio signal to a remote computing unit. The remote computing unit configured to generate a condition status signal based on at least one of an unsupervised machine learning process or a supervised machine learning process. The controller is configured to receive the condition status signal from the remote computing unit and communicate a condition status based on the received condition status signal.

### CROSS-REFERENCE TO RELATED APPLICATIONS

This application claims priority to U.S. provisional application No. 62/795,811 filed on Jan. 23, 2019 incorporated herein by reference in its entirety.

### STATEMENT REGARDING FEDERALLY SPONSORED RESEARCH OR DEVELOPMENT

This invention was made with government support under Grant Nos. 1544753 and 1633259, awarded by the National Science Foundation. The government has certain rights in the invention.

### BACKGROUND OF THE INVENTION

Machinery malfunctions have significant negative effects on the manufacturing industry, including unscheduled downtime leading to the under-utilization of equipment and staff, the production of off-spec products leading to waste of finished product and raw materials, as well as costly-repairs and inefficient maintenance schedules. All of these effects increase the cost of manufacturing and can result in loss of revenue, directly affecting the margin of profitability, and thus the competitiveness for these companies.

The majority of existing solutions for machinery condition monitoring are typically vibration based systems where data is gathered using route-based spot measurements or strategically coupled sensors. The deployment and maintenance of these sensors usually involves an asset shutdown as they are directly coupled to specific points of the machine. The interpretation of the vast amounts of data that these systems can generate utilizes a high level of expertise in vibration analysis and time to carry out.

Any developing machine fault that involves rotating and sometimes non-rotating components will typically generate an acoustic signal. Rotational assets generate acoustic signals when operating “normally”, which mean that deviations from this “normal” state can be detected. The manufacturing industry has accepted the use of acoustic monitoring as a tool for non-destructive testing (“NDT”) of machine health for over many decades. These applications include crack detection in pressure vessels and fault detection in rotating equipment, such as rollers, shafts, gearboxes, and suction rolls. Many industries make use of acoustic sensing for the detection of machinery condition. For example, acoustic signals have been used to diagnose die wear in the machining industry since the 1970s. It was noted that the major advantage of these acoustic emissions was their manifestation at frequencies much higher than the machines operational fundamental and ambient environmental ranges. This means that there is a wealth of useful acoustic information in the range above the majority of the existing ambient plant noise, which is tilted towards the low frequencies.

Wideband or ultrasonic sensing has been used for industrial condition monitoring. This is typically in the form of handheld meters that rely on manual probing of equipment or panning across machinery to detect anomalous sound levels. These signals are usually generated by leaks from high pressure gas lines or electrical arcing. When an excessive decibel level is observed by a trained operator, this is an indication of a fault at a particular location on the piece of machinery under scrutiny. This approach is usually part of a reactionary maintenance routine and is not well suited to detect faults as they develop. Furthermore, as with most vibration monitoring, it relies on human experts to manually inspect and interpret the data.

Thus, what is needed in the art is a system, method and computer-accessible medium for machine condition monitoring which can overcome the deficiencies described above.

### SUMMARY OF THE INVENTION

In one embodiment, a system for monitoring a condition of a machine includes an acoustic detector configured to capture an audio signal of the machine; and a controller communicatively coupled to the audio detector and configured to transmit the audio signal to a remote computing unit, the remote computing unit configured to generate a condition status signal based on at least one of an unsupervised machine learning process or a supervised machine learning process; where the controller is configured to receive the condition status signal from the remote computing unit and communicate a condition status based on the received condition status signal. In one embodiment, the unsupervised machine learning process is trained on normal recordings and identifies anomalies as deviations from normal. In one embodiment, the unsupervised machine learning process is trained on normal operation audio only. In one embodiment, the unsupervised machine learning process is trained to detect a failure signal at SNRs below audible ranges. In one embodiment, unsupervised detection of failure signals is provided as fault state data to train supervised models for more specific fault detection. In one embodiment, the unsupervised machine learning process is configured to identify regions of the signal that contain large residual to classify as anomalous. In one embodiment, the unsupervised machine learning process utilizes a model comprising at least one of Principal Component Analysis (PCA), Spherical K-Means, Independent Component Analysis (ICA), Gaussian Mixture Models (GMM), ICA+Spherical K-Means, Isolation Forests and One-Class Support Vector Machines (OC-SVM). In one embodiment, the supervised machine learning process is trained to take audio features as input and produce an output representing the likelihood of a specific failure. In one embodiment, the supervised machine learning process is trained using a labeled dataset of recordings containing audio representing correct functionality and audio representing different types of known failures. In one embodiment, a single model is implemented to jointly identify all fault types of interest utilizing multi-label classification. In one embodiment, a separate model for each fault type is trained utilizing binary classification. In one embodiment, the supervised machine learning process utilizes a model comprising at least one of Random Forest, Gradient Boosting, Support Vector Machine, Deep Neural Networks, Convolutional Neural Networks and Recurrent Neural Networks. In one embodiment, the supervised machine learning process utilizes data for training the model collected at a machine site or by simulation. In one embodiment, the system includes an acoustical database communicatively coupled to the remote computing unit. In one embodiment, the acoustical database includes a plurality of acoustic signals in an audible range. In one embodiment, the acoustical information includes an acoustic signal in an ultrasonic range. In one embodiment, the acoustic detector is a micro-electromechanical systems microphone.

In one embodiment, a system for detecting a problem with at least one machine includes a computer hardware arrangement configured to: receive acoustical information regarding the at least one machine; generate detection information by analyzing the received acoustical information with a machine learning model; and detecting the problem with the at least one machine based on the detection information.

In one embodiment, a method for detecting a problem with at least one machine includes the steps of receiving acoustical information regarding the at least one machine; generating detection information by analyzing the received acoustical information with a machine learning model; and using a computer hardware arrangement, detecting the problem with the at least one machine based on the detection information.

In one embodiment, a system for detecting a problem with at least one machine, includes at least one acoustical sensor; and a processing arrangement configured to: receive, from the at least one acoustical sensor, acoustical information regarding the at least one machine; generate detection information by analyzing the received acoustical information with a machine learning model trained with an acoustical database; and detecting the problem with the at least one machine based on the detection information.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of an exemplary system for monitoring the condition of a machine according to an exemplary embodiment of the present disclosure;

FIG. 2 is a diagram of machine learning procedures according to an exemplary embodiment of the present disclosure;

FIG. 3 is a diagram of a dashboard used for monitoring the condition of a machine according to an exemplary embodiment of the present disclosure;

FIG. 4 is a further diagram of a dashboard used for monitoring the condition of a machine according to an exemplary embodiment of the present disclosure;

FIG. 5 is an illustration of a block diagram of an exemplary system in accordance with certain exemplary embodiments of the present disclosure;

FIG. 6A is a diagram of an exemplary acoustic sensor according to an exemplary embodiment of the present disclosure;

FIG. 6B is a picture of a digital micro-electromechanical systems acoustic sensing module according to an exemplary embodiment of the present disclosure;

FIG. 6C is an image of deployed sensors according to an exemplary embodiment of the present disclosure;

FIG. 7A is a chart of environmental sound classification results according to an exemplary embodiment of the present disclosure;

FIG. 7B is a chart illustrating bioacoustic classification results according to an exemplary embodiment of the present disclosure;

FIG. 8A is a flow diagram of a method for generating a model for diagnosing machine and using such model according to an exemplary embodiment of the present disclosure;

FIG. 8B is a flow diagram of a method for predicting a condition of a machine according to an exemplary embodiment of the present disclosure.

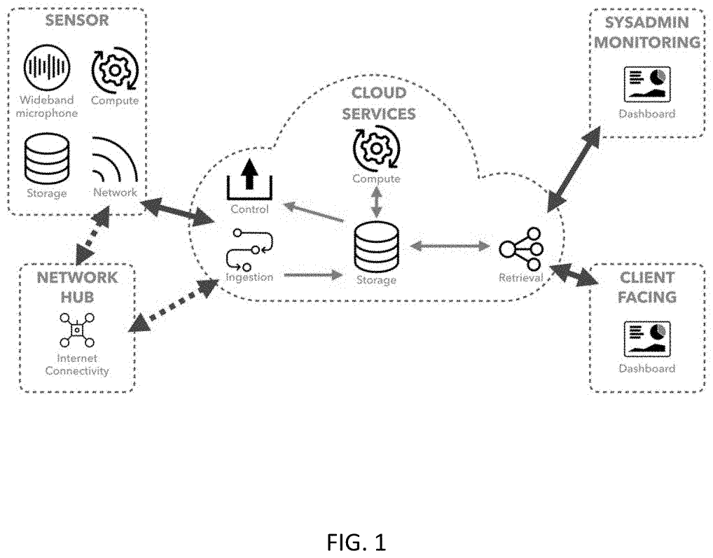

### DETAILED DESCRIPTION OF THE INVENTION

It is to be understood that the figures and descriptions of the present invention have been simplified to illustrate elements that are relevant for a more clear comprehension of the present invention, while eliminating, for the purpose of clarity, many other elements found in systems and methods of machine condition monitoring. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is a system and method for machine condition monitoring.

Embodiments of the invention enable the integration of an acoustic sensor, machine learning and a cloud infrastructure to provide a complete solution for machine condition monitoring. The exemplary system, method, and computer-accessible medium can be used for real-time machine condition monitoring via ultra-wideband acoustic sensors. The exemplary system can automatically identify faults and anomalies in machinery as they develop and generate alerts, facilitating stakeholders to take action as soon as possible, minimizing unscheduled downtime, repair costs and material waste.

The system can include the following components:

1) Acoustic sensor (e.g., hardware): a remote-sensor with custom designed ultra-wideband acoustic hardware for capturing and transmitting acoustic emissions from machinery;

2) Automatic analysis (e.g., software): state-of-the-art machine learning software that automatically analyzes the audio signal captured by the sensor, detects faults, anomalies and generates alerts; and

3) Cloud infrastructure: supports long-term data storage and retrieval, bi-directional communication between the system (e.g. issuing alerts) and stakeholder (e.g. providing feedback and querying historical data), and optionally running the analytics software, which can run either on the cloud server or directly on the sensor (e.g., edge computation). The cloud infrastructure provides the back end for both a client-facing dashboard (e.g., for monitoring alerts, querying historical data and providing user feedback) and for a sysadmin-facing dashboard (e.g., for monitoring the performance and uptime of the deployed acoustic sensors).

The exemplary system, method, and computer-accessible medium can include an acoustic sensor, machine learning, and cloud infrastructure to be used for machine condition monitoring.

Exemplary Ultra-Wideband Acoustic Sensor

The sensor hardware includes three main functional units: (i) the sensing module, (ii) the sensor core, and (iii) the networking components. A description of each unit is included below.

Exemplary Acoustic Sensing Module

The sensing module can be built around an ultra-wideband (e.g., 20-80,000 Hz) microelectromechanical systems (“MEMS”) microphone mounted to a small circular printed circuit board (“PCB”). This ultra-wideband capability facilitates the microphone to receive acoustic machinery fault emissions at frequencies above the majority of the existing ambient plant noise, which can be biased towards lower frequencies. This microphone features a large dynamic range and high sound pressure level (“SPL”) capabilities to transduce sound levels effectively in high noise environments. The microphone can be robust to extreme shifts in environmental conditions and electrical/radio frequency interference as is common in industrial settings. The module can employ either an analog microphone with an inline high frequency analog to digital converter (“ADC”) or a digital microphone for direct routing to the sensor's main compute core via the I2S, TDM or PDM audio interface standards. These audio feeds can be shielded to reduce RF interference and all direct current (“DC”) power lines can be conditioned for minimal power supply noise influence on the microphone. The sensing module can also incorporate temperature and humidity sensors to provide information on environmental conditions at the module's location to monitor any possible effects on the microphone. The module itself can be enclosed within a windshield to reduce the effects of airflow on the microphone signal and to reduce particulate matter blocking the microphone port. It can be mounted to a flexible gooseneck which can be securely mounted to the sensors main housing.

Exemplary Sensor Core

The main sensor housing contains the compute core, which incorporates high-power processing capabilities including a central processing unit (“CPU”) and/or graphics processing unit (“GPU”) for local processing and interpretation of the ultra-wideband raw audio data. The sensor includes high speed random-access memory (“RAM”) for real-time audio processing, including a persistent storage medium to house: the operating system (“OS”), operational codebase of the sensor and its machine learning models. Raw audio data can be processed and fed to the local machine learning models while the sensor can be operational or in another configuration, this audio data can be transmitted securely to cloud based services for server based processing. High level machinery health metrics can be generated continuously by the machine learning models including the probability of a detection of a range of fault types at varying levels of severity, for example, inner-race bearing fault, belt slipping or broken tooth on gear. These metrics can be transmitted to the remote cloud services or stored locally on the persistent storage medium if the transmission fails. In a different configuration, only audio features can be computed and transmitted to cloud services for cloud based fault identification. Data on the sensors operational state can be logged and transmitted for remote sensor fault detection and health monitoring. The sensor also facilitates for remote codebase, machine learning model and configuration updates over the air (“OTA”). The sensor can accept power from a number of sources, such as: regular domestic and industrial outlets with varying supply voltages, low power DC lines or power over Ethernet (“POE”).

Exemplary Networking

For data communications the sensor includes the capability for a range of securely encrypted high and low frequency wireless radio communications and the option for wired Ethernet connectivity. Each sensor can connect directly to an existing wireless network such as: plant Wi-Fi or cellular network for access to cloud services. In another configuration, an internet connected hub can be employed which broadcasts a wireless network that all local sensors connect to, which provides sensors access to cloud services. This hub can be internet connected via: cellular network, Ethernet, connected to existing plant Wi-Fi, or other suitable communications network. Sensors also have the capability to make multi-hop communications with this hub via other localized sensors within closer hub proximity.

Exemplary Machine Learning

The exemplary system, method, and computer-accessible medium can detect known machinery faults and anomalous behavior. This can be achieved through machine learning procedures operating on the audio signal captured by the acoustic sensor, for example deep convolutional neural networks. The analysis procedures can run on the cloud (e.g., remote server) or directly on the sensor (e.g., edge). The automated analytics can include the following:

Learning an “audio embedding” (e.g., feature learning): using large quantities of unlabeled audio data to learn a numerical representation of the audio signal (e.g., an “embedding or “feature”) that can be highly efficient for audio classification.

Training a supervised model for fault detection: using a labeled audio dataset containing recordings of correct operation and recordings of known failures to train a supervised machine learning model to detect known failure modes.

Developing a model for anomaly detection: developing a function, statistical or machine learning procedure to model “normal operation” based on the audio signal and detect when the signal deviates from this normal operation, triggering an alert.

Model deployment: deploying the failure detection and anomaly detection procedures to run continuously either on the cloud (e.g., a remote server) or directly on the sensor hardware (e.g., “edge computation”). The latter potentially uses model compression. As more data is acquired models can be re-trained and deployed, resulting in a continuous train-deploy loop leading to the continuous improvement of system performance.

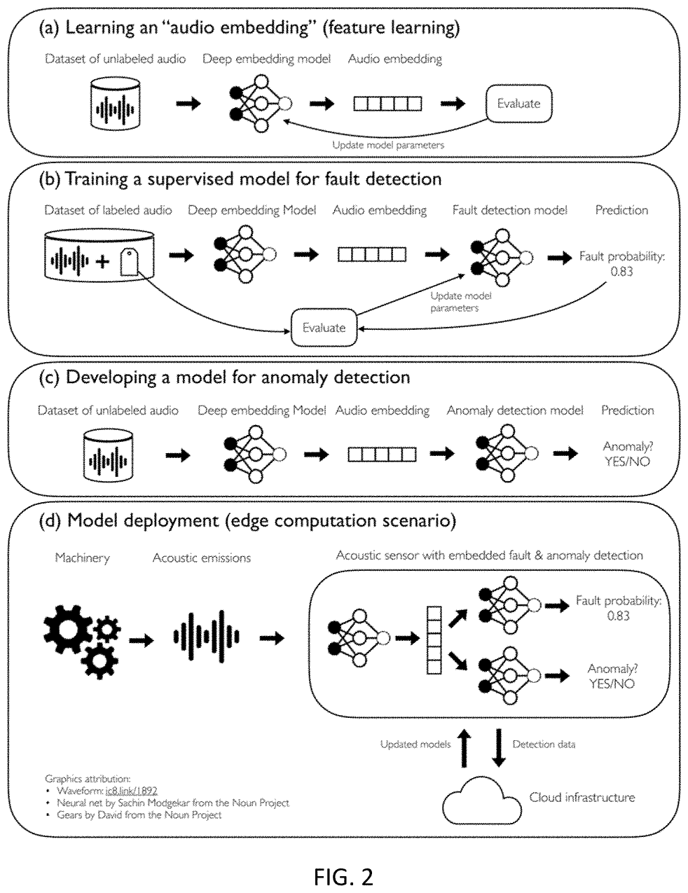

The aforementioned procedures are shown in FIG. 2. Further details about each procedure are described below.

Exemplary Learning an “Audio Embedding” (e.g., Feature Learning)

Acquiring large amounts of labeled audio data (e.g., audio recordings that can be labeled as either correct machinery operation or incorrect operation with the type of failure specified, e.g. “bearing fault”) can be challenging, primarily due to the human effort utilized in labeling the data. To reduce the need for labeled audio data, self-supervised training procedures can be used to learn an “audio embedding”, for example, a transformation of the audio signal into a numerical representation (e.g., “embedding” or “feature”) that can be highly efficient for training audio classification procedures. By using such embedding, supervised machine learning models can be trained using limited amounts of labeled audio data and still obtain high classification accuracy. As such, the embedding can replace the use of standard features such as MFCC or mel spectrograms. Examples of self-supervised strategies that could be used include, but are not limited to, audio-visual correspondence (e.g., the “Look, Listen and Learn” method) and triplet-loss optimization of convolutional neural networks (e.g. deep metric learning.

Exemplary Training a Supervised Model for Failure Detection

Identifying known machinery failures can be achieved by training a supervised machine learning procedure, for example a deep convolutional neural network. The model can be trained to take audio features as input (e.g. standard features such as MFCC or a mel-spectrogram, or a deep audio embedding as described in the previous section) and produce an output between 0-1 representing the likelihood of a specific failure. The procedure can be trained using a labeled dataset of recordings containing audio representing correct functionality and audio representing different types of known failures. The exemplary system, method, and computer-accessible medium can either use a single model to jointly identify all fault types of interest (e.g., multi-label classification), or train a separate model for each fault type (e.g., binary classification). In the former case, the model outputs an independent likelihood value for each fault type, where the value can be between 0-1 representing the likelihood of that specific fault being detected. In the latter case, each model outputs a single value representing the likelihood of the specific fault the model was trained to identify.

Given the output of the model(s) (e.g., a value between 0-1 for each fault type), determining that a fault occurred can be achieved by defining a threshold above which an alert can be triggered. The process can involve more advanced post-processing of the model output (e.g. temporal smoothing and temporal modeling). The threshold value can be fixed or dynamic, the same or different for each fault type, and can be determined automatically based on a data-driven process or set manually based user defined goals/needs.

Examples of machine learning models that can be used include, but are not limited to, Random Forest, Gradient Boosting, Support Vector Machine, Deep Neural Networks, Convolutional Neural Networks, Recurrent Neural Networks.

Data for training the model can be collected at a deployment site (e.g., the facility where the machinery to be monitored is operating) or by simulating different faults in-house using hardware designed for machinery fault simulation.

Exemplary Anomaly Detection

Anomaly detection is the process of identifying that a data stream has diverged significantly from its expected range of values. Using anomaly detection, the system can identify potentially faulty operation even when a specific known fault may not be identified. This facilitates the system to generate alerts for machines and fault types for which labeled data may not be available. Anomaly detection can be achieved by means of an engineered novelty detection function, an unsupervised machine learning procedure or statistical model. Examples include, but are not limited to, ARIMAX, RPCA and RNN. The model takes an input a representation of the audio signal which can be, for example, standard features (e.g. MFCC or mel spectrogram), the deep audio embedding, or some other representation of the audio signal. The model generates an alert whenever an anomaly is detected where, as in the fault detection case; thresholds for alert generation can be determined automatically via data-driven processes or manually based on user needs and goals.

Exemplary Model Deployment

Given a model (e.g. a trained model for fault detection or an unsupervised model for anomaly detection), the model can be deployed to generate alerts given a continuous audio stream from the machinery being monitored. Two primary options are available for running the model:

Cloud: the model can be run on a server, with audio data, or audio features, streamed from the sensor to the server for the purpose of generating predictions.

Edge computation: the model can be run directly on the hardware of the sensor.

Various combinations of Cloud-based and Edge computation can also be used.

The exemplary system, method, and computer-accessible medium can run computationally intense models on powerful servers. Alternatively, or in addition, the model can be sufficiently light in terms of resource requirements to be able to run on the sensor hardware, but can have the advantage of distributing computation across all sensors reducing the load on the cloud server. It can also be a relevant option when (e.g. for security reasons) transmitting data back to the server may not be an option. In the edge computation scenario, model compression can be achieved through a number of model compression procedures, for example DeepIOT or Deep Compression.

Independently of where the models are deployed, anomaly detection and fault detection can operate in parallel to provide optimal detection of both known fault types and previously unseen malfunctions.

As more data is collected (e.g. via the client-facing dashboard described in subsequent sections), the supervised fault detection model(s) can be re-trained on increasing amounts of labeled data. This leads to a continuous train-deploy loop where model(s) performance improves over time as more labeled data is collected by the system. Data from similar assets (e.g., machines) across multiple deployment sites can be leveraged to improve model performance, alleviating the need to conduct an initial data collection and labeling process for assets for which models already exist, even if these assets come from a new, previously unmonitored location.

Unsupervised Machine Learning: An initial focus is on unsupervised methods, meaning that models are only trained on normal recordings and identify anomalies as deviations from normal. The focus on unlabeled methods is beneficial because it is much easier to collect information about how machinery sounds in normal operation. Conversely, failures are relatively sparse and can have a large variation in their characteristics so they are hard to get a significant amount of data to train on. Unsupervised models, trained on purely normal operation audio, are able to detect a failure signal at SNRs well below audible ranges. The unsupervised detection of these failure signals also provides fault state data that can be used when training supervised models for more specific fault detection. Unsupervised fault detection has primarily focused on methods that represent a signal by frequently occurring components. This allows us to identify regions of the signal that contain large residual errors and can therefore be considered anomalous. The primary models used that follow this method are reconstructions using: Principal Component Analysis (PCA), Spherical K-Means, Independent Component Analysis (ICA), Gaussian Mixture Models (GMM), and ICA+Spherical K-Means. Other unsupervised models including Isolation Forests and One-Class Support Vector Machines (OC-SVM) were also used and compared. The best performing model across multiple datasets is ICA, providing detections between −10 and −15 dB signal to noise ratio (SNR) depending on the dataset. At this point the fault is still qualitatively undetectable by human ears. Depending on the temporal evolution of a fault this foresight can equate to weeks or even months.

Supervised Machine Learning: Identifying known machinery failures is achieved by training a supervised machine learning algorithm, for example a deep convolutional neural network. The model is trained to take audio features as input (e.g. standard features such as MFCC or a mel-spectrogram, or a deep audio embedding) and produce an output between 0-1 representing the likelihood of a specific failure. The algorithm is trained using a labeled dataset of recordings containing audio representing correct functionality and audio representing different types of known failures. One can either use a single model to jointly identify all fault types of interest (multi-label classification), or train a separate model for each fault type (binary classification). In the former case, the model outputs an independent likelihood value for each fault type, where the value is between 0-1 representing the likelihood of that specific fault being detected. In the latter case, each model outputs a single value representing the likelihood of the specific fault the model was trained to identify. Examples of machine learning models that can be used include (but are not limited to) Random Forest, Gradient Boosting, Support Vector Machine, Deep Neural Networks, Convolutional Neural Networks, Recurrent Neural Networks. Data for training the model can be collected at a deployment site (i.e. the facility where the machinery to be monitored is operating) or by simulating different faults in-house using hardware designed for machinery fault simulation.

A combination of unsupervised and supervised fault detection methods will lead to a generalized, efficient, and informative fault prediction system, where anomaly detection models can identify general faults/abnormal conditions and supervised models can identify specific faults where examples are available. By collecting more recordings describing the operating and failure conditions of critical machinery components, these models can be used to detect faults well before they fail, improving the maintainability of assets.

Cloud Infrastructure and Dashboard Interfaces

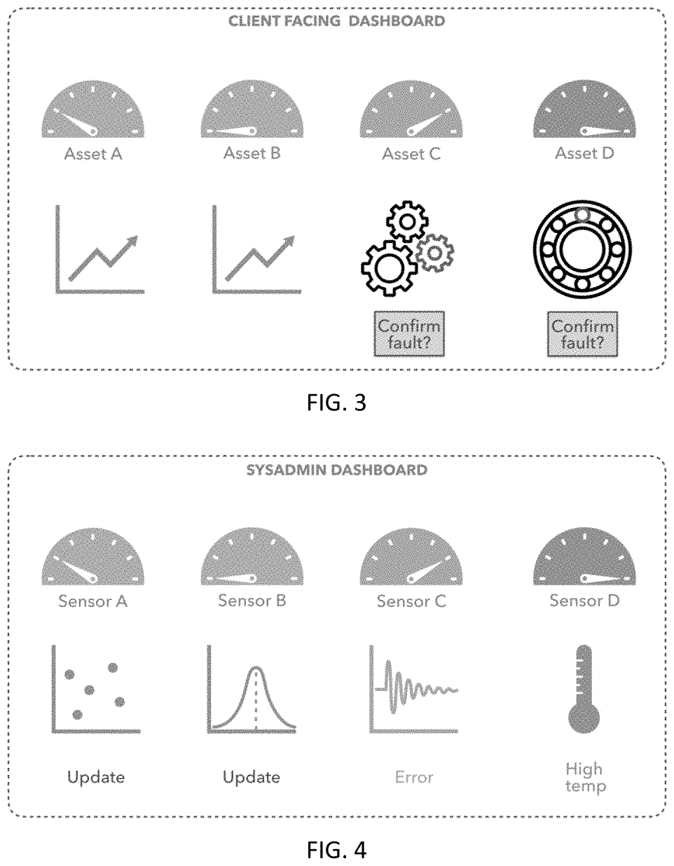

The cloud-based infrastructure and client/sysadmin dashboard interfaces consolidate the compute, connectivity and storage functionality of the system. The cloud services are described below. The dashboard interfaces, illustrated by ways of example in FIGS. 3 and 4, are also described further below.

Exemplary Cloud Infrastructure

Ingestion: Ingestion services can handle all data uploads from active sensors. This data can include raw sensor data such as raw audio data or sensor status information, and edge computed machinery health metrics. Ingestion servers can accept data from multiple sensors, handling these varying loads and moving data to the relevant storage locations.

Control: A control service can facilitate for automated remote access to deployed sensor nodes. This enables remote: updating of machine learning models, sensor codebase changes, and querying of sensor status.

Storage: Raw sensor data and machine health metrics can be routed to various locations dependent on data type and its future use. Raw audio data can be stored for later retrieval on storage file systems, with time series sensor data including machinery health metrics inserted into suitable databases for efficient future retrieval.

Computation: Dedicated compute services facilitate for the processing and analysis of the various data streams retrieved from the sensor network. This cloud based computing facilitates for model retraining to facilitate the generation of more accurate machine learning models as new training data can be uploaded. This can also perform machinery health determinations when delivered raw audio data or audio features. This computing power can also be utilized to query the large volumes of time series data retrieved from each deployed sensor to uncover historical patterns of machinery failure or sensor network operation information and diagnostics. This includes combining machinery health insight from multiple sensor nodes at varying geographical locations to optimize overall sensor network operations.

Retrieval: The insights generated by the compute services, alongside the sensor status information can be delivered via highly available services such as Application Programming Interfaces “(APIs”). These facilitate for web-based user interfaces to serve up relevant data over the internet to remote locations in an efficient manner. User feedback such as fault identifications via web-based dashboards can also be retrieved via this bidirectional API.

Exemplary Dashboard Interfaces

Exemplary Client facing dashboard: As illustrated in the simplified diagram of FIG. 3, an example of a client facing dashboard illustrates real-time machinery health information to the relevant stakeholder in an accessible and relevant way, including historical and predicted trends of machinery failure. Importantly, the dashboard support bidirectional communication, including methods for the stakeholder to provide information and feedback regarding alerts generated by the system. Such feedback includes confirmation of whether a fault was indeed present following a system alert. This information can then be used to label the audio data that generated the alert, in this way increasing the amount of labeled data in the system. This facilitates the continuously retraining of the models on increasing amounts of labeled data to continuously improve their performance.

Exemplary Sysadmin dashboard: A simplified example of a System Administrator, or Sysadmin dashboard is given in FIG. 4. This dashboard displays real-time or near real-time status information on the sensor network, including alerting and monitoring systems to maintain sensor network uptime. It is intended to be used by the sensor network administrator to perform additional functions including: updating sensors, remote diagnostics and troubleshooting, and network status data querying.

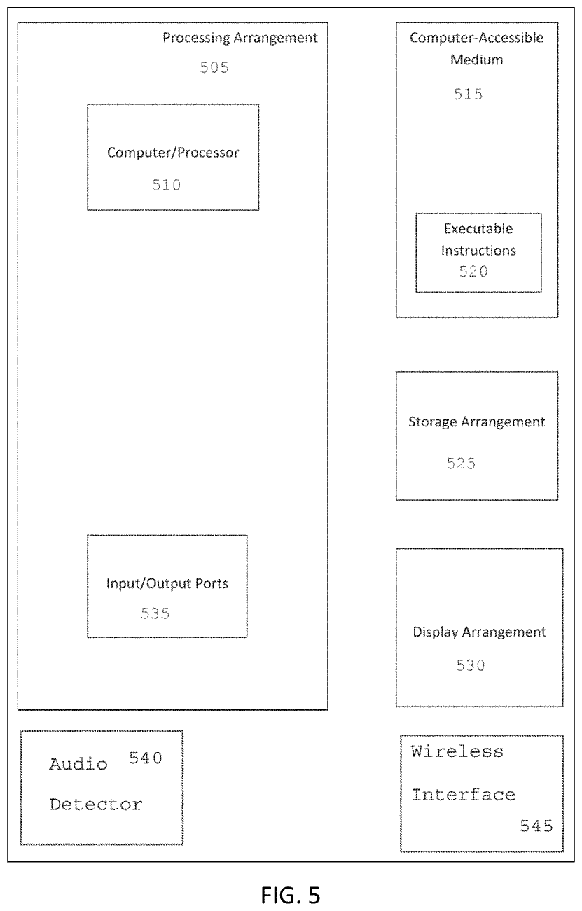

FIG. 5 shows a block diagram of an exemplary embodiment of a sensor according to the present disclosure. For example, exemplary procedures in accordance with the present disclosure described herein can be performed by a processing arrangement and/or a computing arrangement (e.g., computer hardware arrangement) 505. Such processing/computing arrangement 505 can be, for example entirely or a part of, or include, but not limited to, a computer/processor 510 that can include, for example one or more microprocessors, and use instructions stored on a computer-accessible medium (e.g., RAM, ROM, hard drive, or other storage device).

As shown in FIG. 5, for example a computer-accessible medium 515 (e.g., as described herein above, a storage device such as a hard disk, floppy disk, memory stick, CD-ROM, RAM, ROM, etc., or a collection thereof) can be provided (e.g., in communication with the processing arrangement 505), which can store the exemplary prediction model therein. The computer-accessible medium 515 can contain executable instructions 520 thereon. In addition or alternatively, a storage arrangement 525 can be provided separately from the computer-accessible medium 515, which can provide the instructions to the processing arrangement 505 so as to configure the processing arrangement to execute certain exemplary procedures, processes, and methods, as described herein above, for example.

Further, the exemplary processing arrangement 505 can be provided with or include an input/output ports 535, which can include, for example a wired network, a wireless network (e.g., Wireless Interface 545), the internet, an intranet, a data collection probe (e.g., Audio Detector 540), a sensor, etc. As shown in FIG. 5, the exemplary processing arrangement 505 can be in communication with an exemplary display arrangement 530, which, according to certain exemplary embodiments of the present disclosure, can be a touch-screen configured for inputting information to the processing arrangement in addition to outputting information from the processing arrangement, for example. Further, the exemplary display arrangement 530 and/or a storage arrangement 525 can be used to display and/or store data in a user-accessible format and/or user-readable format.

The system, method, and computer-accessible medium, according to an exemplary embodiment of the present disclosure, can be used to continuously monitor the condition of manufacturing machinery. A network of remote acoustic sensing devices with embedded artificial intelligence (“AI”) for sound recognition can be used that can automatically detect and diagnose the early signs of machine failure. Acoustic emissions, both in the audible and ultrasound range, facilitates the exemplary sensors to be non-contact and thus easy to install, capable of monitoring multiple parts per sensor, and able to produce earlier warnings than those possible with existing solutions. Further, AI can be used for sound recognition, which can result in fast and scalable analytics in real-time with minimal expertise utilized (e.g., without the need for a machine operator to diagnose a problem with the machine). An exemplary cyber-infrastructure integrating edge computing, cloud data storage and an easy-to-use dashboard can be used to facilitate navigation, retrieval and operation.

Exemplary Automated Analytics: the system, method, and computer-accessible medium, according to an exemplary embodiment of the present disclosure, can utilize machine-learning-based audio analysis (e.g., referred to as machine listening), and can provide actionable insight significantly faster than human-based analysis, and can be easily scaled to thousands of assets. The interpretation of this high-level insight can utilize minimal expertise from technicians compared to existing condition monitoring technology.

Exemplary Non-Contact Ultrasound Modality: the exemplary acoustic sensor can capture airborne audio signals (e.g., signals audible to the human ear) across the audible (e.g., <20 kHz) and ultrasonic (e.g., between 20-80 kHz) ranges. The system, method, and computer-accessible medium, according to an exemplary embodiment of the present disclosure, can be non-contact, for example, not mounted/coupled to a machine, simplifying installation and maintenance, and removing a large barrier to widespread adoption. Further, a single acoustic sensor can be used to monitor entire sections of a machine, unlike vibration or IRT, which can reduce the number of sensors utilized to monitor an asset. Certain types of common faults, such as bearing faults, can be identified significantly earlier using ultrasound compared to vibration, resulting in earlier alerts and giving the manufacturer more time to take action. Thus, the exemplary system, method, and computer-accessible medium can be more robust than typical systems that rely solely on vibration sensing.

Exemplary Cloud infrastructure and Edge Computing: the exemplary integrated cloud-based data acquisition, storage, and navigation makes it easy to retrieve and interact with both real-time and historical data in a manner that is absent in current solutions. Further, the exemplary sensor has a computing core capable of running the machine listening analytics in-situ, reducing the amount of sensitive data that is transmitted wirelessly, which can increase cyber-security around the operation and reduce storage costs.

Acoustic Sensing

Micro-electromechanical systems (“MEMS”) microphone technologies can be used for remote acoustic sensing. The production process used to manufacture these MEMS devices provides an extremely high level of part-to-part consistency and robustness, making them particularly well suited for multi-sensor remote sensing applications. Intensive anechoic testing was conducted on a large number of microphones in order to determine the differences between microphone batches. Sensor analysis were performed, including the effects and suitability of sensor housing, the computing core, microphone mounting conditions, sensor mounting conditions, weather protection, different powering strategies and RFi/EM mitigation.

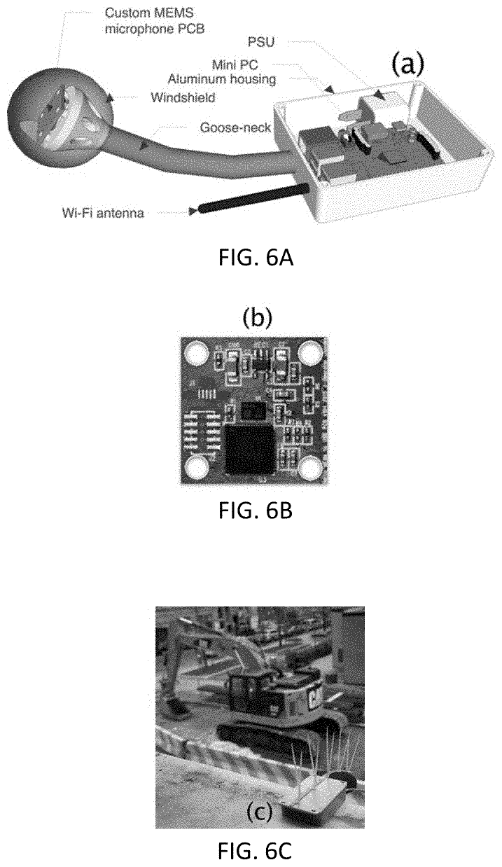

Prior acoustical systems were susceptible to radio frequency (“RF”) and electromagnetic (“EM”) interference. In contrast, the exemplary system, method, and computer-accessible medium, according to an exemplary embodiment of the present disclosure, as shown in FIG. 6B, can utilize digital MEMS design and on-board microcontroller (“MCU”). The use of an on-board MCU can facilitate the efficient, hardware-level, filtering of the incoming audio signal to compensate for the frequency response of the MEMS microphone before any further analysis can be carried out. The acoustical characteristics of the exemplary microphones and MCU audio systems were measured anechoically in comparison to reference laboratory grade measurement microphones. The exemplary digital MEMS microphone can include a wide dynamic range of 32-120 dBA, enabling accurate and linear signal capture from very-quiet to very-loud environments, and can have an effectively flat frequency response across the audible frequency band for accurate audio capture and environmental sound pressure level (“SPL”) data generation.

The exemplary current sensor unit shown in FIGS. 6A and 6C can be based on a quad-core Raspberry Pi 2B single-board computer (“SBC”) outfitted with the exemplary custom MEMS microphone sensing module shown in FIG. 6B. Of course, it will be appreciated that other SBC's, including a custom dedicated SBC, can be used as an alternative. The sensor's computing core can be housed within an aluminum casing, or other suitable shielding material, in order to reduce RF interference and enhance internally generated heat dissipation. The microphone module can be mounted externally via a repositionable metal goose-neck facilitating the sensor to be reconfigured for deployment in varying locations such as wall-sides, poles, and ledges.

The exemplary system, method, and computer-accessible medium, according to an exemplary embodiment of the present disclosure, can include a dedicated computing core, which can provide for edge computing, particularly for in-situ machine listening which can be used to automatically and robustly identify the presence of common sound sources.

Exemplary Machine Listening

The semantic analysis of auditory scenes has been the subject of research in speech, music and environmental sound. One of the most challenging problems in this domain can be identifying multiple sound sources in complex mixtures, for example, with source overlap, background noise, and a combination of persistent and transient sounds.

Automatically classifying sounds into categories can utilize a sound taxonomy. An exemplary taxonomy that is focused on urban environmental sounds, compiled the largest annotated dataset available at the time for environmental sound classification can be used to establish a baseline for performance using Mel Frequency Cepstral Coefficients (“MFCC”) coupled with a Support Vector Machine classifier (“SVM”). Standard audio representations can be obtained by convolving the input signal x with a filterbank ψ_{λ} taking the modulus, and passing the result through a low-pass filter ϕ(t): X(t,λ)=|x*ψ_{λ}|*ϕ(t). The parameters of the filterbank λ can be used to obtain specific representations, such as a magnitude Fourier, Constant-Q or Mel spectrum, from which MFCC can be derived. This can be referred to as a convolutional layer. In addition, X can be projected into the space defined by a set of learned basis functions D, such that Y=XD can be a code vector that can be passed into a classifier. This can be referred to as a fully-connected layer. A convolutional layer (e.g., based on a Mel spectrum) can be used with a learned fully-connected layer using spherical k-means to obtain state-of-the-art results for sound source classification in urban environments, significantly outperforming the MFCC baseline. Depth to the convolutional layer can be added, which can result in a deep scattering spectrum: X₂(t, λ₁, λ₂)=∥x*ψ_{λ1}|*ψ_{λ2}|*ϕ(t). The exemplary results show that adding depth can successfully model local temporal dynamics and can be invariant to time-shifts, all of which can enhance performance, particularly in noisy conditions, and can reduce model complexity.

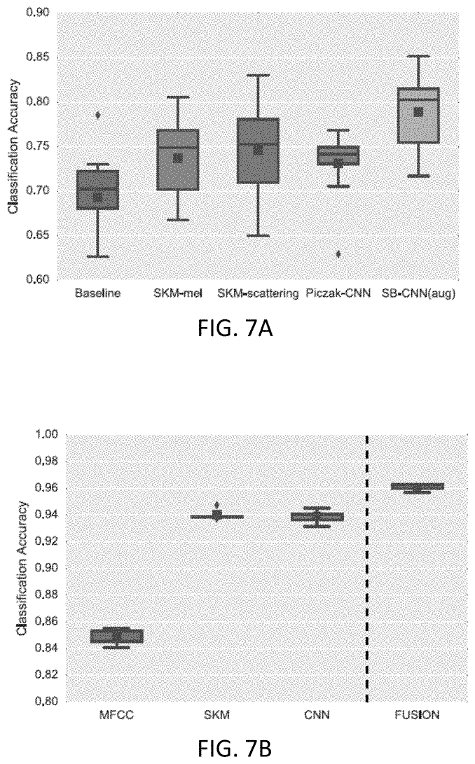

The exemplary results obtained using deep convolutional signal representations and feature learning facilitated the use of deep convolutional neural networks (“CNN”) to environmental sound classification, using a framework that can be fully integrated from feature learning to classification. A CNN coupled with data augmentation and model ensembling can be applied for machine listening, and can provide classification performance for both urban and bioacoustic audio signals, representing a high classification accuracy. (See e.g., charts shown in FIGS. 7A and 7B). Exemplary studies were performed on machinery sounds from sources such as engines, jackhammers, drills, and AC units.

An exemplary machine listening model for environmental sound, can be developed including data collection activities such as the definition of audio taxonomies, remote acoustic sensing, data augmentation and synthesis and audio data annotation.

In contrast to other systems, the exemplary system, method, and computer-accessible medium does not require manually designing a digital signal processing pipeline for automatically classifying the condition of a machine from incoming audio data. An exemplary data-driven process can be used by which a machine learning model can be trained to automatically classify the machine condition from incoming audio, during which it can automatically learn the relevant series of transformations to apply to the input data. Further, the model can be trained to directly predict the condition of the machine (e.g., “correct” vs. “faulty” or identifying specific fault types, for example, “shaft misalignment”), as opposed to predicting an intermediate parameter and checking whether the parameter is within some manually predefined range. An exemplary process of training a model, and subsequently deploying it, are described in more detail below.

Exemplary Training

Training a machine learning model for audio classification can include the following:

Training audio: recordings of the machine during operation, including correct and incorrect operation (e.g., operation in the presence and absence of malfunctions).

Training labels: annotations (e.g., in the format of, for example, text or CSV files) indicating the operational state of the machine at each moment in time for each of the training audio recordings. This can include a table indicating, for each recording, the times during which a malfunction occurs.

Machine learning model: the model can take the audio signal, or a transformed version of the audio signal, as an input and return a number between 0-1 corresponding to the likelihood of the machine having a malfunction. Where multiple specific malfunctions can be identified simultaneously, the function can return a value between 0-1 for every malfunction under consideration. Training the model can include updating the parameters of the function such that its output can be as accurate as possible using an automatic learning algorithm.

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out the preferred embodiments of the present invention, and are not to be construed as limiting in any way the remainder of the disclosure.

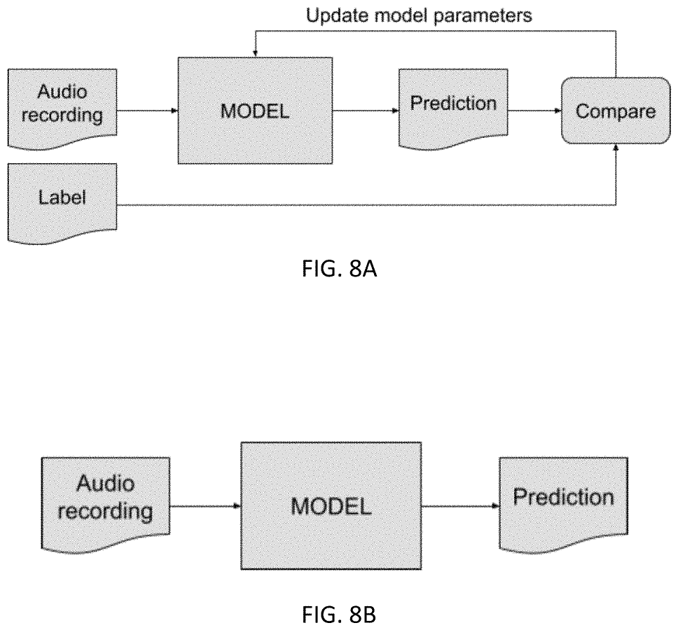

An exemplary process of training the machine learning model is described below and shown in FIG. 8A.

Exemplary Training audio can include of audio recordings captured by the sensor's ultrasonic microphone. A continuous recording can be split into short segments (e.g., the duration of which can vary from a few milliseconds to several seconds). The segments can be presented to the model either in their “raw” form (e.g., as a series of audio samples), or after having been transformed into a time-frequency representation using a transform such as the short-time Fourier transform (“STFT”) or another suitable transform.

Exemplary Training labels can include of text or CSV files, or any format that can store textual information, which contain, for each audio recording, labels indicating the condition of the machine during every moment in time in the recording. This can include timestamps indicating regions of correct operation and regions of faulty operation. This can also include timestamps indicating regions of correct operation and regions of incorrect operation where, for incorrect operation, the specific malfunction type is specified.

Exemplary Machine learning model can include a trainable function which can take a short audio segment as input and return a value indicating the likelihood of a malfunction (e.g., generic or a specific type of malfunction). This can be performed using its parameters, and the training process can include updating these parameters such that the output of the function can match the provided training labels as best as possible. This training process (e.g., updating the model parameters) can be automatic, and may only require the availability of training audio and labels, and the selection of model type and hyper-parameters. The model type can, for example, be a Support Vector Machine or a Deep Neural Network, and can include different types of machine learning models.

During training, the exemplary model can be provided with one or more audio segments as input, and can produce an output indicating the likelihood of a malfunction in each segment. This number, or numbers, can then be compared against the audio segment's corresponding label, which can indicate whether a malfunction occurred or not. The difference between the output of the model and the label can be used to update the parameters of the model automatically by using a machine learning, or optimization, procedure. This can be repeated until the training process can converge (e.g., the parameters of the model are no longer being modified or the expected error of the model over the training data has been minimized).

Exemplary Prediction Inference

Once the model has been trained (e.g., the parameters of the model have been modified to maximize its accuracy on the training data), the model can be deployed. For example, it can be used to generate new predictions on new audio data. During this phase the model parameters can be kept fixed. (See e.g., FIG. 8B). Model training can be performed on a computer/server machine. Once the model has been trained, it can be deployed on the hardware of the acoustic sensor, performing predictions directly on the sensor. Alternatively, the sensor may only capture the audio and send it to a remote server which runs the model to generate predictions. When the model predicts the presence of a malfunction (e.g., when the likelihood for a malfunction as predicted by the model is above a threshold value), a notification can be sent to alert the user.

Exemplary Sensing Module

A custom ultra-wideband acoustic sensing module can be utilized. In order to monitor acoustic anomalies that span the audible and ultrasonic frequency ranges (e.g., about 20-80,000 Hz) the design of an ultra-wideband sensing module can be utilized. Various measurements can be used to determine the specifications for the exemplary ultrasonic MEMS microphone. This microphone can be coupled with a suitable highly-integrated audio system-on-chip (“SOC”) that can be capable of handling the high data-rates produced by ultrasonic audio capture. This system can also provide the ability to attenuate/accentuate certain frequency bands based on the frequency composition of the manufacturing environment, which can be determined using the exemplary system, method, and computer-accessible medium. Sustained microphone operation in terms of deviations in frequency-dependent sensitivity can be used to assess the sensing module's ability to reliably gather data under lab-based varying sound pressure levels.

Various selected sensor housing, microphone, and audio subsystem can be assessed for their resilience to varying: acoustic (e.g., effective dynamic and frequency range), RF (e.g., simulated wide-band RF noise) and atmospheric environments (e.g., shifts in airborne particulate matter and environmental parameters). The exemplary system, method, and computer-accessible medium, according to an exemplary embodiment of the present disclosure, can also be used for electrical and mechanical microphone shielding to mitigate the effects of these potentially damaging influences. The exemplary sensor computing cores can be tested for resistance to power supply fluctuations, as can be common in high power manufacturing plants, with suitable protection implemented to mitigate the effects.

Exemplary Networking

The exemplary system, method, and computer-accessible medium, according to an embodiment of the present disclosure, can include an exemplary sensor network. Exemplary sensor networks can be used, which can include the implementation of a cloud-connected, hard-wired network hub providing connectivity to localized wireless sensors. A suitable wireless network technology can be used based on the RF measurements of manufacturing plants. Sensor range and signal quality under varying RF conditions and internal plant layouts can be determined to optimize the networking hardware and protocol choices. The code-base can be developed and lab trialed for data gathering, control, and transmission from sensor to server. Various suitable sensor control and connectivity, data collection, transmission, and ingestion units can be incorporated.

Exemplary Data Collection

The exemplary system, method, and computer-accessible medium, according to an exemplary embodiment of the present disclosure, can be used to produce a taxonomy of known machinery faults and a collection of labeled, ground-truth audio data. The taxonomy of known faults can be produced by combining building sound taxonomies and datasets with discussions with domain experts at the pilot facility to identify the most relevant and frequent fault types. Using this exemplary taxonomy, the collected audio data can be labeled in collaboration with domain experts.

Exemplary Model

An exemplary automatic fault classification model can be created based on machine listening models for environmental sound recognition, in order to optimize the performance. To achieve this, a comparison of signal representations as input to the network, including linear time-frequency representations (e.g., spectrogram), logarithmic representations (e.g., mel-spectrogram and constant-Q transform), and wavelet-based representations (e.g., scattering transform) can be performed. Thus, the exemplary system, method, and computer-accessible medium does not need to compute and operational parameter in order to diagnose a problem with a machine. The exemplary system, method, and computer-accessible medium, according to an exemplary embodiment of the present disclosure, can extend acoustic representations to span the ultrasonic frequency range of the re-designed acoustic sensor. This can be followed by an empirical comparative evaluation of different model architectures to determine accuracy, memory and computational complexity trade-offs, as well as an assessment of the utility/impact of audio data augmentation. This can be tested using standard machine learning evaluation metrics such as classification accuracy, F-measure, and area under the ROC curve (“AUC”).

Various exemplary procedures can be used to improve the robustness of the exemplary model. For example, background adaptation procedures can be used to increase the robustness of the exemplary model to varying background acoustic conditions, including approaches based on feature design and dynamic networks. In addition, the performance of the exemplary model can be compared to simpler anomaly detection procedures to determine whether other anomaly detection procedures can be used to complement the exemplary model. Anomaly detection cannot provide fault type diagnostics but can provide useful information in the absence of labeled data and can aid in the identification of events of interest in the data for further labeling.

Exemplary Model Compression

Exemplary model compression procedures can be used to minimize the computational complexity and memory footprint of the developed machine listening model while maintaining its classification accuracy. An exemplary compressed model can utilize the computing core of the acoustic sensor by including information related to environmental sensors. The continuous uptime of the sensor's computing core (e.g., under varying environmental conditions) and classification accuracies consistent with those of the uncompressed model can be used.

A full-stack infrastructure can be utilized for data ingestion, analysis, sensor control, real-time sensor monitoring, and diagnostics. In order to visualize the inferences made by the integrated sensor-analytics solution, a cloud-hosted dashboard was developed.

The exemplary system, method, and computer-accessible medium, according to an exemplary embodiment of the present disclosure, can include the integration of an exemplary sensor and exemplary machine listening models into a single solution. AI-powered acoustic sensor can be used that can automatically detect and diagnose machinery faults in real-time. The exemplary system, method, and computer-accessible medium, can incorporate machine learning (“ML”) based analytics to provide actionable insight significantly faster than human-based analysis, and can be easily scaled to thousands of assets. The ML-based analytics can be incorporated into the acoustic sensor such that each acoustic sensor can analyze the from a machine without the need to forward the raw data for further analysis. This can enhance the security of the exemplary system, method, and computer-accessible medium because all acoustic information can be analyzed locally, and not sent over a network where it can be intercepted. This can also prevent network congestion as constantly sending raw can tax a wireless or wired network.

Including the AI in the acoustic sensor can provide for quicker diagnosis of machine problems, which can prevent damage to the machine (e.g., workers can fix a problem quicker or shut down a machine prior to significant damage being done to the machine). The AI in the acoustic sensor can be in communication with a server to provide updated modeling information to the server. The server can use this information to modify (e.g., update) the model based on new diagnostic information (e.g., additional acoustical information). After the model has been updated, the server can disseminate the updated model to all acoustic sensors having the AI thereon.

Alternatively, the sensor can just include an acoustic sensor, and the raw data can be provided to a server for analysis. Data can be constantly sent in real time, or bursts of data at particular intervals (e.g., 1 minute, 5 minutes, 10 minutes, 15 minutes, etc.) can be sent over the network. The network can be any suitable wireless (e.g., Wi-Fi) or wired network. For example, a separate network can be setup such that the acoustic sensors send the raw data over this separate network. This can alleviate any congestion that can occur if the acoustic sensors are constantly sending the raw data over a network used for other communication. An exemplary benefit of processing the raw data at a server, is that the AI can be constantly updated based on the raw data. This can provide for increased accuracy in diagnosing a machine.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

1. A system for monitoring a condition of a machine comprising:
an acoustic detector configured to capture an audio signal of the machine; and
a controller communicatively coupled to the audio detector and configured to transmit the audio signal to a remote computing unit, the remote computing unit configured to generate a condition status signal based on at least one of an unsupervised machine learning process or a supervised machine learning process;
wherein the controller is configured to receive the condition status signal from the remote computing unit and communicate a condition status based on the received condition status signal.

2. The system of claim 1, wherein the unsupervised machine learning process is trained on normal recordings and identifies anomalies as deviations from normal.

3. The system of claim 1, wherein the unsupervised machine learning process is trained on normal operation audio only.

4. The system of claim 1, wherein the unsupervised machine learning process is trained to detect a failure signal at signal-to-noise ratios below audible ranges.

5. The system of claim 1, wherein unsupervised detection of failure signals is provided as fault state data to train supervised models for more specific fault detection.

6. The system of claim 1, wherein the unsupervised machine learning process is configured to identify regions of the signal that contain large residual to classify as anomalous.

7. The system of claim 1, wherein the unsupervised machine learning process utilizes a model comprising at least one of Principal Component Analysis (PCA), Spherical K-Means, Independent Component Analysis (ICA), Gaussian Mixture Models (GMM), ICA+Spherical K-Means, Isolation Forests and One-Class Support Vector Machines (OC-SVM).

8. The system of claim 1, wherein the supervised machine learning process is trained to take audio features as input and produce an output representing the likelihood of a specific failure.

9. The system of claim 1, wherein the supervised machine learning process is trained using a labeled dataset of recordings containing audio representing correct functionality and audio representing different types of known failures.

10. The system of claim 1, wherein a single model is implemented to jointly identify all fault types of interest utilizing multi-label classification.

11. The system of claim 1, wherein a separate model for each fault type is trained utilizing binary classification.

12. The system of claim 1, wherein the supervised machine learning process utilizes a model comprising at least one of Random Forest, Gradient Boosting, Support Vector Machine, Deep Neural Networks, Convolutional Neural Networks and Recurrent Neural Networks.

13. The system of claim 1, wherein the supervised machine learning process utilizes data for training the model collected at a machine site or by simulation.

14. The system of claim 1 further comprising:
an acoustical database communicatively coupled to the remote computing unit.

15. The system of claim 14, wherein the acoustical database includes a plurality of acoustic signals in an audible range.

16. The system of claim 14, wherein the acoustical information includes an acoustic signal in an ultrasonic range.

17. The system of claim 1, wherein the acoustic detector is a micro-electromechanical systems microphone.

18. A system for detecting a problem with at least one machine, comprising:
a computer hardware arrangement configured to:
receive acoustical information regarding the at least one machine;
generate detection information by analyzing the received acoustical information with a machine learning model; and
detecting the problem with the at least one machine based on the detection information.

19. A method for detecting a problem with at least one machine, comprising:
providing the system of claim 18 and utilizing the computer hardware arrangement for:
receiving acoustical information regarding the at least one machine;
generating detection information by analyzing the received acoustical information with a machine learning model; and
detecting the problem with the at least one machine based on the detection information.

20. A system for detecting a problem with at least one machine, comprising:
at least one acoustical sensor; and
a processing arrangement configured to:
receive, from the at least one acoustical sensor, acoustical information regarding the at least one machine;
generate detection information by analyzing the received acoustical information with a machine learning model trained with an acoustical database; and
detecting the problem with the at least one machine based on the detection information.
